(19) United States
(12) Patent Application Publication
(10) Pub. No.: US 2016/0284135 A1
(43) Pub. Date: Sep. 29, 2016

(54) Reality Animation Mechanism

(71) Applicants: Gila Kamhi, Zichron Yaakov (IL); Barak Hurwitz, Kibbutz Alonim (IL); Tal Alexander-Amor, Haifa (IL)

(72) Inventors: Gila Kamhi, Zichron Yaakov (IL); Barak Hurwitz, Kibbutz Alonim (IL); Tal Alexander-Amor, Haifa (IL)

(21) Appl. No.: 14/668,155

(22) Filed: Mar. 25, 2015

(51) Int. Cl. G06T 19/20; G06T 7/00; G06T 13/40

(52) U.S. Cl. CPC G06T 19/20; G06T 13/40; G06T 7/0042; G06T 2207/10028

(57) ABSTRACT

A method comprising acquiring depth image data, scanning the depth image data to generate a three-dimensional (3D) model of an object included in the depth image data and animating the object for insertion into an application for interaction with a user.

### FIELD

Embodiments described herein generally relate to computers. More particularly, embodiments relate to computer animation.

### BACKGROUND

For many years there has been a fascination with the concept of toys that interact. For instance, Pinocchio tells a story of a toy puppet boy coming to life, while the movie Toy Story follows a group of toys that come to life when humans are not present. Currently there is no way to enable interaction with an animated version of toys.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a reality animation mechanism according to one embodiment.

FIG. 2 illustrates a reality animation mechanism according to one embodiment.

FIG. 3 illustrates reality animation process according to one embodiment.

FIGS. 4A-4E illustrate embodiments of an object for animation.

FIG. 5 illustrates a computer system suitable for implementing embodiments of the present disclosure according to one embodiment.

### DETAILED DESCRIPTION

In the following description, numerous specific details, such as component and system configurations, may be set forth in order to provide a more thorough understanding of the present invention. In other instances, well-known structures, circuits, and the like have not been shown in detail, to avoid unnecessarily obscuring the present invention.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

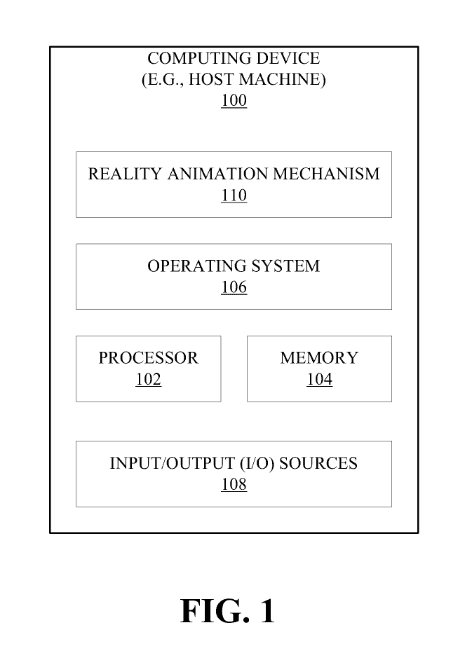

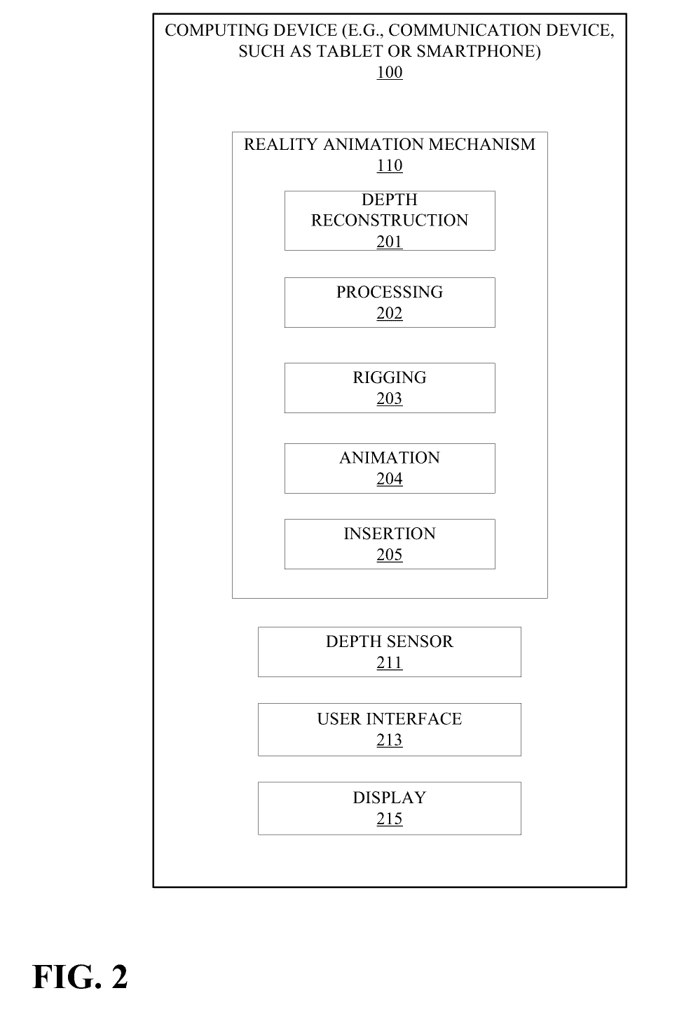

FIG. 1 illustrates one embodiment of a computing device 100. According to one embodiment, computing device 100 serves as a host machine for hosting a reality animation mechanism 110. In such an embodiment, reality animation mechanism 110 receives data from one or more depth sensing devices (e.g., a camera array or depth camera) and scans the data to acquire a three-dimensional model of an object. In one embodiment, the object is a toy that a user owns or has built. Subsequently, reality animation mechanism 110 animates the object for insertion into an application as an animated figure within digital content for interaction with a user. In a further embodiment, joint information is received and used to annotate the scanned model in order to automate a character rigging process. Additionally, reality animation mechanism 110 may receive information regarding a type of material from which the object is comprised to facilitate correction and refinement of the scanned 3D model. Reality animation mechanism 110 includes any number and type of components, as illustrated in FIG. 2, to efficiently perform reality animation, as will be further described throughout this document.

Computing device 100 may also include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, Ultrabook™ system, etc.), e-readers (e.g., Kindle® by Amazon®, Nook® by Barnes and Nobles®, etc.), media internet devices (“MIDs”), smart televisions, television platforms, wearable devices (e.g., watch, bracelet, smartcard, jewelry, clothing items, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/0) sources 108, such as touchscreens, touch panels, touch pads, virtual or regular keyboards, virtual or regular mice, etc.

FIG. 2 illustrates a reality animation mechanism 110 according to one embodiment. In one embodiment, reality animation mechanism 110 may be employed at computing device 100 serving as a communication device, such as a smartphone, a wearable device, a tablet computer, a laptop computer, a desktop computer, etc. In a further embodiment, reality animation mechanism 110 includes any number and type of components, such as: depth reconstruction module 201, processing logic 202, rigging module 203, animation module 204 and insertion module 205. Further, computing device 100 includes depth sensing device 211, user interface 213 and display 213 to facilitate implementation of reality animation mechanism 110.

It is contemplated that any number and type of components may be added to and/or removed from reality animation mechanism 110 to facilitate various embodiments including adding, removing, and/or enhancing certain features. For brevity, clarity, and ease of understanding of reality animation mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

Depth reconstruction module 201 creates a three-dimensional (3D) model by scanning an object from data received from depth sensing device 211. As discussed above, the object may be a toy that a user owns or has built. In such an embodiment, the model has a size range of 10 cm-150 cm. In one embodiment, depth reconstruction module 201 includes real-time volumetric reconstruction of a user's environment using a 3D object scanning and model creation algorithm (e.g. KinectFusion™ developed by Microsoft®). Depth reconstruction module 201 may also include depth maps as output. In such an embodiment, the depth maps are derived either directly from sensor 211 or as an end result of projecting depth from an accumulated model. In more sophisticated embodiments, depth reconstruction module 201 incorporates an element of scene understanding, offering per-object 3D model output. In such an embodiment, this is achieved via image/point-cloud segmentation algorithms and/or user feedback via user interface 213. In a further embodiment, depth reconstruction module 201 receives information regarding the object from an external source (e.g., a user via user interface 213, a virtual library, etc.). As a result, depth reconstruction module 201 may recognize skeleton joints of the object and annotate the model during the scan.

Depth sensing device 211 may include an image capturing device, such as a camera. Such a device may include various components, such as (but are not limited to) an optics assembly, an image sensor, an image/video encoder, etc., that may be implemented in any combination of hardware and/or software. The optics assembly may include one or more optical devices (e.g., lenses, mirrors, etc.) to project an image within a field of view onto multiple sensor elements within the image sensor. In addition, the optics assembly may include one or more mechanisms to control the arrangement of these optical device(s). For example, such mechanisms may control focusing operations, aperture settings, exposure settings, zooming operations, shutter speed, effective focal length, etc. Embodiments, however, are not limited to these examples.

Depth sensing device 211 may further include one or more image sensors including an array of sensor elements where these elements may be complementary metal oxide semiconductor (CMOS) sensors, charge coupled devices (CCDs), or other suitable sensor element types. These elements may generate analog intensity signals (e.g., voltages), which correspond to light incident upon the sensor. In addition, the image sensor may also include analog-to-digital converter(s) ADC(s) that convert the analog intensity signals into digitally encoded intensity values. Embodiments, however, are not limited to these examples. For example, an image sensor converts light received through optics assembly into pixel values, where each of these pixel values represents a particular light intensity at the corresponding sensor element. Although these pixel values have been described as digital, they may alternatively be analog. As described above, the image sensing device may include an image/video encoder to encode and/or compress pixel values. Various techniques, standards, and/or formats (e.g., Moving Picture Experts Group (MPEG), Joint Photographic Expert Group (JPEG), etc.) may be employed for this encoding and/or compression.

Processing module 202 processes the 3D model. In one embodiment, processing module 202 simplifies the 3D model and removes unwanted objects (e.g., a floor, walls, furniture, etc.) captured in the image. In one embodiment, the model is simplified by automatically measuring attributes (e.g., length, size, etc.) and locating components (e.g., hands, legs, body, head, etc.). Subsequently, an estimation is made of a number of component bricks that fit inside each component. For instance, cups may be used as the component bricks in an embodiment featuring a toy cup man. Additionally, color may be used to estimate average color if the model includes multiple colors.

In a further embodiment, processing module 202 analyzes (or measures) the scanned object in order to perform corrections that may be necessary. As a result, processing module 202 may rebuild problematic areas detected in the object during the analysis (e.g., if information is available for a toy building block and scanning quality is low). For example, if the model is made up of Lego® bricks, processing module 202 can correct the scanned 3D model by replacing areas with information from a Lego® brick library where the scanning is not sufficient (e.g., has holes, incomplete depth data).

Rigging module 203 performs a character rig of the model. A character rig is a digital skeleton bound to the 3D mesh. Like a real skeleton, a rig is made up of joints and bones, each of which act as a “handle” that is used to bend the model into a desired pose. In one embodiment, a rig is created by defining a number of animation variables that control the location of one or more of the points on the 3D mesh. According to one embodiment, rigging module 203 performs automatic rigging based on annotated joint information registered during scanning of the object. The automated rigging process estimates the location of bones within the model. In a further embodiment, rigging module 203 also performs automatic skinning, which generates the model with connected bones. In such an embodiment, a bone closest to each vertex is found an given a skinning weight.

Animation module 204 generates 3D animated images of the object based on the rigging. In one embodiment, the object is animated by adjusting animation variables over time. For example, to animate a scene of the model speaking, animation module 204 may adjust one or more animation variables to impart motion to, for example, the model's lips. In some embodiments, animation module 204 adjusts the animation variables for each frame of a scene.

Insertion module 205 inserts the animated object into an application. In one embodiment, an application developer may insert the created character into a game and add animation (e.g., walk, run, hand raise, etc.). According to one embodiment, the object is inserted into a mixed (or hybrid) reality application that encompasses augmented reality and augmented virtuality.

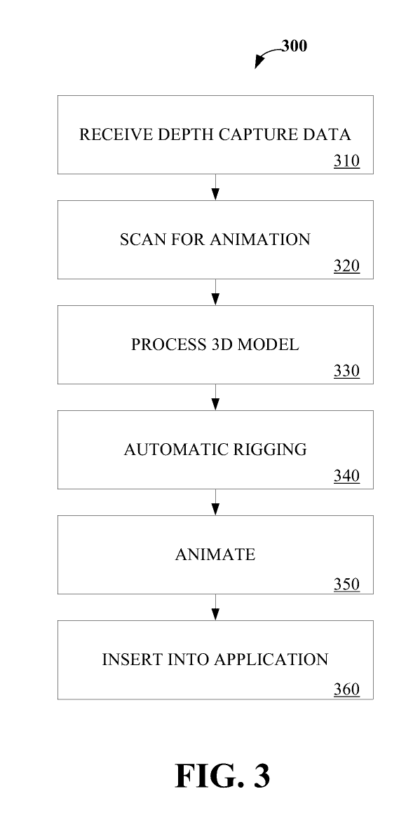

FIG. 3 illustrates a process 300 for facilitating reality animation at computing device 100 according to one embodiment. Process 300 may be performed by processing logic that may include hardware (e.g., circuitry, dedicated logic, programmable logic, etc.), software (such as instructions run on a processing device), or a combination thereof. In one embodiment, process 300 may be performed by reality animation mechanism 110 of FIG. 1. Process 300 is illustrated in linear sequences for brevity and clarity in presentation; however, it is contemplated that any number of them can be performed in parallel, asynchronously, or in different orders. For brevity, many of the details discussed with reference to FIGS. 1-3 may not be discussed or repeated hereafter.

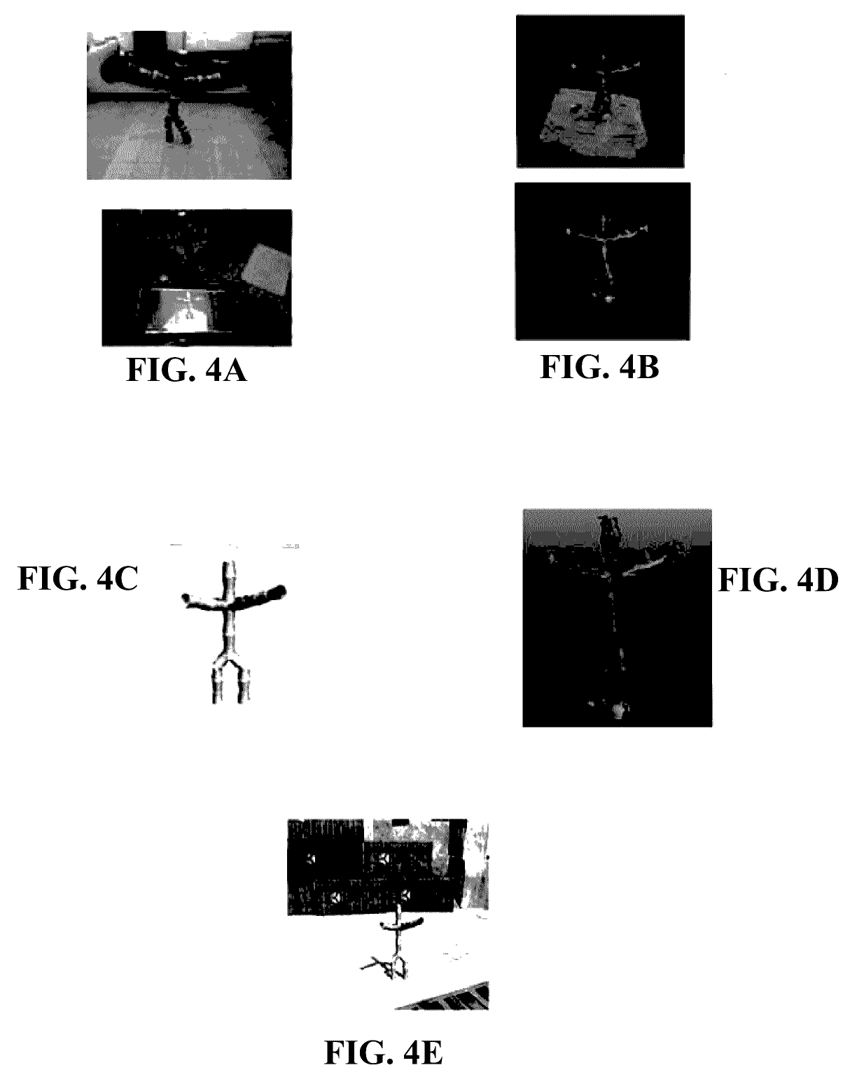

Process 300 begins at processing block 310, where depth reconstruction module 201 acquires RGB-D images from depth sensing device 211 and reconstructs a 3D model from the images. At processing block 320, the images are scanned to acquire an object for animation. FIG. 4A illustrates one embodiment of a toy cup man that is scanned for animation. As discussed above, information regarding the model (or object information) being made of cups is also received during the scanning

This information as implemented at processing block 330 during the processing of the model. FIG. 4B illustrates one embodiment of the toy cup man after being processed to remove background objects. For instance, FIG. 4B shows that the floor and furniture have been removed. Processing also includes analyzing the object using the object information in order to rebuild problematic areas detected in the object. FIG. 4C illustrates one embodiment of the rebuilt toy cup man after such analysis.

At processing block 340, automatic rigging is performed based on joint information received as a part of the object information. FIG. 4D illustrates one embodiment of the rebuilt toy cup man after rigging is performed. At processing block 350, the model is inserted into an application. FIG. 4E illustrates one embodiment of the toy cup man after being inserted into an application.

The above-described reality animation mechanism enables generation of a computer-animated version of a toy owned by a user. The animated digital 3D model may subsequently be added to a digital game, book, movie (e.g., part of a virtual reality application), or an augmented reality application.

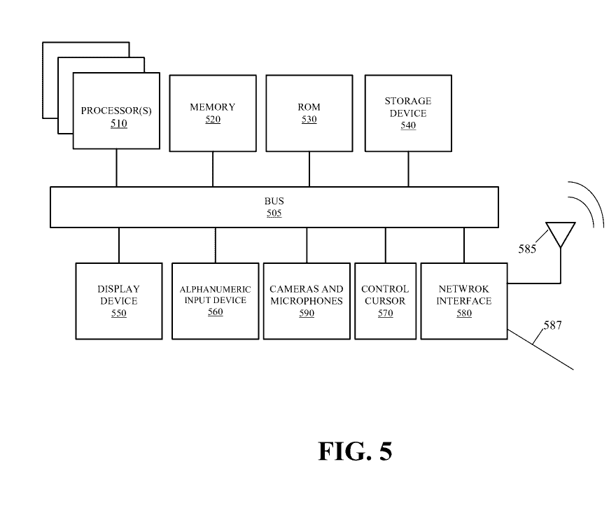

FIG. 5 illustrates an embodiment of a computing system 500. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 500 may be the same as or similar to or include computing device 100, as described in reference to FIGS. 1 and 2.

Computing system 500 includes bus 505 (or, for example, a link, an interconnect, or another type of communication device or interface to communicate information) and processor 510 coupled to bus 505 that may process information. While computing system 500 is illustrated with a single processor, electronic system 500 and may include multiple processors and/or co-processors, such as one or more of central processors, graphics processors, and physics processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 760, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes a reality animation apparatus comprising a depth sensing device to acquire image and depth data and an animation reality module to receive the image and depth data to generate a three-dimensional (3D) model of an object and animate the object for insertion into an application for interaction with a user.

Example 2 includes the subject matter of Example 1, wherein the animation reality module comprises a depth reconstruction module to scan the image and depth data and generate the 3D model and a processing logic to process the 3D model to implement corrections of the model.

Example 3 includes the subject matter of Example 2, wherein the depth reconstruction module receives joint information during scanning of the image and depth data.

Example 4 includes the subject matter of Example 3, wherein the depth reconstruction module recognizes skeleton joints of the object to annotate the model.

Example 5 includes the subject matter of Example 4, wherein the processing logic simplifies the 3D model and removes unwanted objects captured in the image and depth data.

Example 6 includes the subject matter of Example 5, wherein the processing logic analyzes the object to determine corrections that are to be performed.

Example 7 includes the subject matter of Example 6, wherein the processing logic performs corrections to rebuild problematic areas detected in the object during the analysis.

Example 8 includes the subject matter of Example 7, wherein the processing logic receives information regarding a type of material from which the object is comprised to facilitate correction of the object model.

Example 9 includes the subject matter of Example 8, wherein the animation reality module further comprises a rigging module to perform a character rig of the object model and an animation module to generate 3D animated images of the object based on the rigging.

Example 10 includes the subject matter of Example 9, wherein the rigging module performs automatic rigging based on the annotated joint information.

Example 11 includes the subject matter of Example 10, wherein the animation reality module further comprises an insertion module to insert the object model into the application.

Example 12 includes the subject matter of Example 11, wherein the application is a mixed reality application.

Example 13 includes the subject matter of Example 1, wherein the object for insertion is a toy.

Some embodiments pertain to Example 14 that includes a method comprising acquiring depth image data, scanning the depth image data to generate a three-dimensional (3D) model of an object included in the depth image data and animating the object for insertion into an application for interaction with a user.

Example 15 includes the subject matter of Example 14, further comprising receiving joint information during the scanning of the depth image data to recognize skeleton joints of the object to annotate the model.

Example 16 includes the subject matter of Example 15, further comprising processing the 3D model to implement corrections to the model.

Example 17 includes the subject matter of Example 16, wherein the processing comprises simplifying the 3D model and removing unwanted objects captured in the depth image data.

Example 18 includes the subject matter of Example 17, wherein the processing further comprises analyzing the object to determine corrections that are to be performed and performing corrections to rebuild problematic areas detected in the object.

Example 19 includes the subject matter of Example 18, wherein the processing further comprising receiving information regarding a type of material from which the object is comprised to facilitate correction of the object model.

Example 20 includes the subject matter of Example 18, wherein animating the object further comprises performing a character rig of the object model and generating 3D animated images of the object based on the rigging.

Example 21 includes the subject matter of Example 20, further comprising inserting the object model into an application.

Some embodiments pertain to Example 22 that includes a computer readable medium having instructions, which when executed by a processor, cause the processor to perform operations comprising acquiring depth image data, scanning the depth image data to generate a three-dimensional (3D) model of an object included in the depth image data and animating the object for insertion into an application for interaction with a user.

Example 23 includes the subject matter of Example 22, having instructions, which when executed by a processor, cause the processor to further perform receiving joint information during the scanning of the depth image data to recognize skeleton joints of the object to annotate the model.

Example 24 includes the subject matter of Example 23, having instructions, which when executed by a processor, cause the processor to further perform processing the 3D model to implement corrections to the model.

Example 25 includes the subject matter of Example 24, wherein the processing comprises simplifying the 3D model and removing unwanted objects captured in the depth image data.

Example 26 includes the subject matter of Example 25, wherein the processing further comprises analyzing the object to determine corrections that are to be performed and performing corrections to rebuild problematic areas detected in the object.

Some embodiments pertain to Example 27 that includes a computer readable medium having instructions, which when executed by a processor, cause the processor to perform operations according to any of claims 14-21.

Some embodiments pertain to Example 28 that includes an apparatus to perform reality animation, comprising means for acquiring depth image data, means for scanning the depth image data to generate a three-dimensional (3D) model of an object included in the depth image data and means for animating the object for insertion into an application for interaction with a user.

Example 29 includes the subject matter of Example 28, further comprising means for receiving joint information during the scanning of the depth image data to recognize skeleton joints of the object to annotate the model.

Example 30 includes the subject matter of Example 29, further comprising means for processing the 3D model to implement corrections to the model.

Example 31 includes the subject matter of Example 30, wherein the means for processing comprises simplifying the 3D model and removing unwanted objects captured in the depth image data, analyzing the object to determine corrections that are to be performed and performing corrections to rebuild problematic areas detected in the object.

Example 32 includes the subject matter of Example 28, wherein the object for insertion is a toy.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A reality animation apparatus comprising:
a depth sensing device to acquire image and depth data; and
an animation reality module to receive the image and depth data to generate a three-dimensional (3D) model of an object and an animated figure corresponding to the object for insertion into an application for interaction with a user.

2. The apparatus of claim 1, wherein the animation reality module comprises:
a depth reconstruction module to scan the image and depth data and generate the 3D model; and
a processing logic to process the 3D model to implement corrections of the model.

3. The apparatus of claim 2, wherein the depth reconstruction module receives joint information during scanning of the image and depth data.

4. The apparatus of claim 3, wherein the depth reconstruction module recognizes skeleton joints of the object to annotate the model.

5. The apparatus of claim 4, wherein the processing logic simplifies the 3D model and removes unwanted objects captured in the image and depth data.

6. The apparatus of claim 5, wherein the processing logic analyzes the object to determine corrections that are to be performed.

7. The apparatus of claim 6, wherein the processing logic performs corrections to rebuild problematic areas detected in the object during the analysis.

8. The apparatus of claim 7, wherein the processing logic receives information regarding a type of material from which the object is comprised to facilitate correction of the object model.

9. The apparatus of claim 8, wherein the animation reality module further comprises:
a rigging module to perform a character rig of the object model; and
an animation module to generate 3D animated images of the object based on the rigging.

10. The apparatus of claim 9, wherein the rigging module performs automatic rigging based on the annotated joint information.

11. The apparatus of claim 10, wherein the animation reality module further comprises an insertion module to insert the animated figure into the application.

12. The apparatus of claim 11, wherein the application is a mixed reality application.

13. A method comprising:
acquiring depth image data;
scanning the depth image data to generate a three-dimensional (3D) model of an object included in the depth image data; and
generating an animating animated figure corresponding to the object for insertion into an application for interaction with a user.

14. The method of claim 13, further comprising receiving joint information during the scanning of the depth image data to recognize skeleton joints of the object to annotate the model.

15. The method of claim 14, further comprising processing the 3D model to implement corrections to the model.

16. The method of claim 15, wherein the processing comprises:
simplifying the 3D model; and
removing unwanted objects captured in the depth image data.

17. The method of claim 16, wherein the processing further comprises:
analyzing the object to determine corrections that are to be performed; and
performing corrections to rebuild problematic areas detected in the object.

18. The method of claim 17, wherein the processing further comprising receiving information regarding a type of material from which the object is comprised to facilitate correction of the object model.

19. The method of claim 17, wherein animating the object further comprises:
performing a character rig of the object model; and
generating 3D animated images of the object based on the rigging.

20. The method of claim 19, further comprising inserting the animated figure into an application.

21. A computer readable medium having instructions, which when executed by a processor, cause the processor to perform:
acquiring depth image data;
scanning the depth image data to generate a three-dimensional (3D) model of an object included in the depth image data; and
generating an animating animated figure corresponding to the object for insertion into an application for interaction with a user.

22. The computer readable medium of claim 21, having instructions, which when executed by a processor, cause the processor to further perform receiving joint information during the scanning of the depth image data to recognize skeleton joints of the object to annotate the model.

23. The computer readable medium of claim 22, having instructions, which when executed by a processor, cause the processor to further perform processing the 3D model to implement corrections to the model.

24. The computer readable medium of claim 23, wherein the processing comprises:
simplifying the 3D model; and
removing unwanted objects captured in the depth image data.

25. The computer readable medium of claim 24, wherein the processing further comprises:
analyzing the object to determine corrections that are to be performed; and
performing corrections to rebuild problematic areas detected in the object.
